(19) United States
(12) Patent Application Publication
(10) Pub. No.: US 2013/0063622 A1
(43) Pub. Date: Mar. 14, 2013

(54) IMAGE SENSOR AND METHOD OF CAPTURING AN IMAGE

(71) Applicants: Michael SCHOEBERL, Erlangen (DE); Andre KAUP, Effeltrich (DE)

(72) Inventors: Michael SCHOEBERL, Erlangen (DE); Andre KAUP, Effeltrich (DE)

(21) Appl. No.: 13/669,163

(22) Filed: Nov. 5, 2012

Related U.S. Application Data
(63) Continuation of application No. PCT/EP2011/057143, filed on May 4, 2011.

(30) Foreign Application Priority Data
May 7, 2010 (DE) 102010028746.6

(51) Int. Cl. H04N 5/228

(52) U.S. Cl. 348/222.1; 348/E05.031

(57) ABSTRACT

A better compromise between the dynamic range, the spatial resolution, the implementation outlay and the image quality is achieved if different subdivisions of the exposure interval into accumulation intervals are performed for different pixel sensors or pixels. In the event of more than one accumulation interval per exposure interval, the values detected in the accumulation intervals are summed to obtain the respective pixel value. Since the exposure effectively continues to take place for all pixels over the entire exposure interval, no impairment of the image quality arises, or no artifacts arise in image movements. All pixels undergo the same image blur on account of the movement. The additional hardware outlay compared with commercially available pixel sensors is either entirely non-existent or can be kept very small, depending on the implementation. Moreover, a reduction in the spatial resolution is not necessary since the pixels contribute equally to the image capturing.

### CROSS-REFERENCE TO RELATED APPLICATIONS

This application is a continuation of copending International Application No. PCT/EP2011/057143, filed May 4, 2011, which is incorporated herein by reference in its entirety, and additionally claims priority from German Application No. 102010028746.6-31, filed May 7, 2010, which is also incorporated herein by reference in its entirety.

### BACKGROUND OF THE INVENTION

The present invention relates to an image sensor and a method of capturing an image as may be employed, e.g., in a camera, namely a still-picture camera or a video camera.

Image sensors nowadays have a very limited dynamic range, so that many typical scenes cannot be fully imaged. Therefore, as high a dynamic level as possible per shot would be desirable. Previous techniques for a high dynamic range (HDR) exhibit marked image interference in the shooting of moving scenes. High-resolution shots exhibiting correct motional blurring involve a lot of effort.

There are various possibilities of expanding the dynamic range for image sensors, i.e., for HDR. The following group of possibilities provides computational combination of images following a regular shot:
According to a first possibility, individual independent shots of a scene which have been obtained with exposure durations of different lengths are combined with each other. For still pictures, this approach is trouble-free, however, image interference will result in the event of a movement occurring during shooting, as is described in [2]. This possibility is also made use of in video cameras [16]; however, this approach there will also lead to movement artifacts caused by a rolling-shutter readout pattern and by different exposure times of the individual exposures.
An alternative approach according to which individual images are computationally combined with one another, provides that the different measurements for each image point are combined differently to take into account an uncertainty of measurement in the event of movement. The result is an HDR shot without any movement and completely without any motional blurring [10], which is not desired for the capturing of high-quality moving images, however.
Alternative possibilities are based on post-processing of shots and on estimating a movement between two images. These approaches involve clearly more computational power. Such post-processing may be used for reducing the noise and, thus, for increasing the dynamic range for existing video sequences [1]. The capturing of a video sequence with alternating short and long exposures may also result in improved images by means of movement estimation and subsequent interpolation [5]. However, in the event of unfavorable scenes, no success is guaranteed in either case.

Other possibilities of achieving a higher dynamic range start with the sensor design. The following options present themselves:
One possibility is to design improved sensors having a large “full-well capacitance”, so that many electrons may be collected per pixel. The difference between many and few electrons will yield the large dynamic range. However, the problem with this approach is that a large capacitance in each pixel also involves a large pixel area. In addition, in the implementation one has to consider the fact that a large dynamic range also involves a particularly low noise level, a high level of accuracy and slow operation in the area of the readout circuits.
A further possibility consists in using sensors having a non-linear characteristic, such as logarithmic or LIN-LOG characteristics. Systems which are based on such sensors, however, exhibit a large amount of FPN (fixed pattern noise) image interferences that are particularly difficult to compensate for [14].
Finally, it is possible to utilize the sensors in connection with particular modes for multiple readout during exposure, the information collected so far not being deleted during readout [9, 3, 4]. However, direct extrapolation will also lead to artifacts in the event of there being a movement.
A further possibility consists in providing each pixel with an additional circuit which may comprise, e.g., a comparator, a counter, etc. Such additional circuits may be used for controlled imaging with a high level of dynamics. [7] and [6] explain a comparison of various such implementations and their noise behaviors. In the LARS iii principle, for example, each pixel measures not only the intensity up to the end of the exposure but also the point of time of the overflow. This yields pixels with exposure durations of different lengths depending on the brightness and, thus, interferences in dependence on the brightness of the scene in the event of there being a movement.

Further possible approaches to extending the dynamic range provide an array of pixels having different levels of sensitivity in each case [15]:
For example, in [12], utilization of an optical ND (neutral density) filter per pixel with different densities in a fixed arrangement is described, so that an image having a higher level of dynamics may be reconstructed by means of a reconstruction. However, this involves a decrease in the spatial resolution. The optical mask for each image is fixed.
The Eastman Kodak Image Sensor achieves a larger dynamic range and higher sensitivity by means of additional panchromatic pixels. Here, too, a loss of resolution occurs, and additional algorithms for color reconstruction may be used [8].
The Fuji Super CCD additionally comprises very small pixels between the normal pixels and may use additional algorithms for reconstruction [15].

Splitting of the light beam via a beam splitter, for example, while shooting the same scene from the same perspective while using several cameras may be exploited to cover a higher level of dynamics. This enables shooting even without any artifacts. A system comprising three cameras is described in [17], for example. However, a large outlay for mechanical alignment and optical components is involved.

In the field of adaptive systems there is a proposition according to which an LC display is mounted in front of a camera [13]. Starting from an image, the brightness may then be adapted in specific image areas for the further images. Skillful reduction of the brightness in bright image areas may then create exposure of a scene which exhibits correct motional blurring. Some of the above-mentioned possibilities of expanding the dynamic range are not able to produce a high-quality HDR image of a moving scene. Artifacts will arise, since each image point is incorporated in the shot at a different time or with a different effective exposure duration. Software correction comprising estimating and interpolating the movement in the scene is possible; however, the result will invariably be inferior to a real shot.

Systems having image points of different sensitivities, as were also described above, may use different pixels on the image sensor for each of the possible cases, namely “bright” and “dark”. This reduces spatial resolution. Additional electronics in each pixel furthermore leads to reduced sensitivity since in these areas, no light-sensitive surface can be realized.

Systems which circumvent both disadvantages may use additional mechanics. As was mentioned above, it is possible, for example, to provide beam splitters in connection with utilization of several cameras [17] or to use additional optical reducers in front of each pixel [13]. However, said solutions are either extremely expensive or also lead to a reduction in the resolution.

Moreover, U.S. Pat. No. 4,040,076 describes a technique known as “skimming gate”. This technique involves initially reading out some of the accumulated charge of the pixels so as to achieve increased dynamics which, however, may use additional circuitry.

### SUMMARY

According to an embodiment, an image sensor may have: a multitude of pixel sensors, the image sensor being configured to capture an image and is configured such that during capture of the image a first pixel sensor in each one of a first number of non-overlapping first accumulation intervals which succeed each other in an essentially uninterrupted manner and together yield an exposure interval detects one value in each case so as to achieve a number of values which, if the first number is larger than 1, are subjected to a summation so as to achieve a pixel value for the first pixel sensor, and a second pixel sensor in each of a second number of non-overlapping second accumulation intervals which succeed each other in an essentially uninterrupted manner and together yield the exposure interval, detects a value so as to achieve a number of values which, if the second number is larger than 1, are subjected to a summation so as to achieve a pixel value for the second pixel sensor, a subdivision of the exposure interval into the first accumulation intervals differing from a subdivision of the exposure interval into the second accumulation intervals, wherein the multitude of pixel sensors include pixel sensors of a first color sensitivity spectrum and pixel sensors of a second color sensitivity spectrum, the first pixel sensor belonging to the pixel sensors of the first color sensitivity spectrum, and the second pixel sensor belonging to the pixel sensors of the second color sensitivity spectrum, the image sensor being configured such that the subdivision of the exposure interval into accumulation intervals for the pixel sensors of the first color sensitivity spectrum and the pixel sensors of the second color sensitivity spectrum is identical, but for the pixel sensors of the first color sensitivity spectrum is different from that for the pixel sensors of the second color sensitivity spectrum.

According to another embodiment, an camera may have an image sensor, which image sensor may have: a multitude of pixel sensors, the image sensor being configured to capture an image and is configured such that during capture of the image a first pixel sensor in each one of a first number of non-overlapping first accumulation intervals which succeed each other in an essentially uninterrupted manner and together yield an exposure interval detects one value in each case so as to achieve a number of values which, if the first number is larger than 1, are subjected to a summation so as to achieve a pixel value for the first pixel sensor, and a second pixel sensor in each of a second number of non-overlapping second accumulation intervals which succeed each other in an essentially uninterrupted manner and together yield the exposure interval, detects a value so as to achieve a number of values which, if the second number is larger than 1, are subjected to a summation so as to achieve a pixel value for the second pixel sensor, a subdivision of the exposure interval into the first accumulation intervals differing from a subdivision of the exposure interval into the second accumulation intervals, wherein the multitude of pixel sensors include pixel sensors of a first color sensitivity spectrum and pixel sensors of a second color sensitivity spectrum, the first pixel sensor belonging to the pixel sensors of the first color sensitivity spectrum, and the second pixel sensor belonging to the pixel sensors of the second color sensitivity spectrum, the image sensor being configured such that the subdivision of the exposure interval into accumulation intervals for the pixel sensors of the first color sensitivity spectrum and the pixel sensors of the second color sensitivity spectrum is identical, but for the pixel sensors of the first color sensitivity spectrum is different from that for the pixel sensors of the second color sensitivity spectrum.

According to another embodiment, a method of capturing an image with a multitude of pixel sensors, the method may have the following steps in capturing the image: controlling a first pixel sensor, so that in each one of a first number of non-overlapping first accumulation intervals which succeed each other in an essentially uninterrupted manner and together yield an exposure interval, said first pixel sensor detects one value in each case so as to achieve a number of values while—if the first number is larger than 1—summing the values so as to achieve a pixel value for the first pixel sensor, and controlling a second pixel sensor, so that in each of a second number of non-overlapping second accumulation intervals which succeed each other in an essentially uninterrupted manner and together yield the exposure interval, said second pixel sensor detects a value so as to achieve a number of values while—if the second number is larger than 1—summing the values so as to achieve a pixel value for the second pixel sensor, a subdivision of the exposure interval into the first accumulation intervals differing from a subdivision of the exposure interval into the second accumulation intervals, the multitude of pixel sensors including pixel sensors of a first color sensitivity spectrum and pixel sensors of a second color sensitivity spectrum, the first pixel sensor belonging to the pixel sensors of the first color sensitivity spectrum, and the second pixel sensor belonging to the pixel sensors of the second color sensitivity spectrum, the subdivision of the exposure interval into accumulation intervals for the pixel sensors of the first color sensitivity spectrum and the pixel sensors of the second color sensitivity spectrum being identical to one another, but being different for the pixel sensors of the first color sensitivity spectrum from that for the pixel sensors of the second color sensitivity spectrum.

Another embodiment may have a computer program having a program code for performing the method of capturing an image with a multitude of pixel sensors, which method may have the following steps in capturing the image: controlling a first pixel sensor, so that in each one of a first number of non-overlapping first accumulation intervals which succeed each other in an essentially uninterrupted manner and together yield an exposure interval, said first pixel sensor detects one value in each case so as to achieve a number of values while—if the first number is larger than 1—summing the values so as to achieve a pixel value for the first pixel sensor, and controlling a second pixel sensor, so that in each of a second number of non-overlapping second accumulation intervals which succeed each other in an essentially uninterrupted manner and together yield the exposure interval, said second pixel sensor detects a value so as to achieve a number of values while—if the second number is larger than 1—summing the values so as to achieve a pixel value for the second pixel sensor, a subdivision of the exposure interval into the first accumulation intervals differing from a subdivision of the exposure interval into the second accumulation intervals, the multitude of pixel sensors including pixel sensors of a first color sensitivity spectrum and pixel sensors of a second color sensitivity spectrum, the first pixel sensor belonging to the pixel sensors of the first color sensitivity spectrum, and the second pixel sensor belonging to the pixel sensors of the second color sensitivity spectrum, the subdivision of the exposure interval into accumulation intervals for the pixel sensors of the first color sensitivity spectrum and the pixel sensors of the second color sensitivity spectrum being identical to one another, but being different for the pixel sensors of the first color sensitivity spectrum from that for the pixel sensors of the second color sensitivity spectrum, when the program runs on a computer.

A core idea of the present invention consists in that a better compromise may be achieved between the dynamic range, the spatial resolution, the implementation outlay and the image quality if—although each pixel effectively carries out exposure over the entire exposure interval—different subdivisions of said exposure interval into accumulation intervals are performed for different pixel sensors or pixels. In the case of more than one accumulation interval per exposure interval, the values detected in the accumulation intervals are summed in order to obtain the respective pixel value. Since the exposure effectively continues to take place for all pixels over the entire exposure interval, no impairment of the image quality arises, or no artifacts arise in image movements. All pixels undergo the same image blur on account of the movement. The additional hardware outlay compared with commercially available pixel sensors, such as CMOS sensors, for example, is either entirely non-existent or can be kept very small, depending on the implementation. Moreover, a reduction in the spatial resolution is not necessary since the pixels, in principle, contribute equally to the image capturing. In this manner, pixels which accumulate charges more slowly in response to the light to be absorbed because they are less sensitive to the light or because a smaller amount of light impinges on them may be controlled with a finer subdivision, and pixels for which the opposite is true may be controlled with a coarser subdivision, thereby increasing the dynamic range overall while maintaining the spatial resolution and the image quality and while requiring only little implementation outlay.

In accordance with an embodiment, the exposure interval subdivision is performed in dependence on the level of brightness of the image at the different pixel sensors, such that the brighter the image at the respective pixel sensor, the larger the number of accumulation intervals. The dynamic range thus increases even further, since brightly illuminated pixels are less likely to go into saturation, since the exposure interval is subdivided into the accumulation intervals. The subdivisions of the illumination intervals of the pixels or pixel sensors in dependence on the image may be determined individually for each pixel in accordance with a first embodiment. The accumulation interval subdivision is selected to be finer for pixel sensors or pixels in whose positions the image is brighter, and are selected to be less fine for the other pixel sensors, i.e., are selected to exhibit fewer accumulation intervals per exposure interval. The exposure interval subdivider, which is responsible for subdividing the exposure interval into the accumulation intervals, may determine the brightness at the respective pixel sensor from the shot of the preceding image, such as from the pixel value of the preceding image for the respective pixel sensor. Another possibility is for the exposure interval subdivider to currently observe the accumulated amount of light of the pixel sensors during the exposure interval and to end a current accumulation interval and to start a new one when the current accumulated amount of light of a respective pixel sensor exceeds a predetermined amount. The observation may be performed continually or intermittently, such as periodically at intervals that are equal in length and smaller than the exposure time period, and may include, for example, non-destructive readout of an accumulator of the respective pixel sensor.

Instead of setting the exposure interval subdivision into the accumulation intervals for each pixel individually, provision may be made for the exposure interval subdivision into the accumulation intervals to be performed for different disjoint real subsets of the pixel sensors of the image sensor, said subsets corresponding to different color sensitivity spectra, for example. In this case it is also possible to use sensors in addition to the pixel sensors so as to perform image-dependent exposure interval subdivision. Alternatively, representative pixel sensors of the image sensor itself may be used. On the basis of the information thus obtained about the image or the scene, a color spectrum of the image is detected, and the exposure interval subdivision into the accumulation intervals is performed, depending thereon, for the individual pixel sensor groups, such as the individual color components of the image sensor.

### BRIEF DESCRIPTION OF THE DRAWINGS

Embodiments of the present invention will be detailed subsequently referring to the appended drawings, in which:

FIG. 1 shows a graph wherein the response of color channels of a typical image sensor is represented in values, which are coded in a normalized manner, for white light of the color temperature T;

FIG. 2 shows a graph wherein a camera output is plotted over a variation of the amount of light for a color temperature T=2700 K for the red, green and blue color channels (continuous lines) as well as the noise standard deviation (dashed horizontal lines) and the dynamic range limits (dotted vertical lines);

FIGS. 3a to 3c show diagrams wherein the dynamic range at a color temperature T=2700 K for the red, green and blue color channels is represented together with a “safe range” for correct exposure of all of the color channels, specifically once for normal exposure with continuous exposure of the pixels, once for subdividing half of the exposure intervals into accumulation intervals for each primary color, and a different time for continuous exposure for blue pixels at a subdivision of half of the exposure intervals into accumulation intervals for red and green pixels;

FIG. 4 shows a schematic drawing of an image sensor in accordance with an embodiment;

FIG. 5 shows a schematic drawing for illustrating exposure intervals subdivision into accumulation intervals in accordance with an embodiment;

FIG. 6 shows graphs wherein the accumulation state of a pixel sensor is represented over time for various exemplary exposure interval subdivisions into accumulation intervals and different illumination states at the pixel sensors;

FIG. 7 shows a schematic representation of an image sensor in accordance with a further embodiment; and

FIG. 8 shows a block diagram of a section of an image sensor in accordance with a further embodiment.

### DETAILED DESCRIPTION OF THE INVENTION

Before several embodiments of the present application will be described below with reference to the figures, it shall be noted that identical elements which occur in several of said figures are provided with identical reference numerals and that repeated descriptions of said elements are avoided as much as possible, but that the descriptions of said elements with regard to one figure shall also apply to the other figures as long as no contradiction results from the specific descriptions of the respective figure.

In addition, it shall be noted that in the following, the description will initially relate to embodiments of the present application, according to which the exposure interval subdivision into accumulation (sub)intervals is performed, in a manner that is individual for each color, for different colors of an image sensor even though, as will be subsequently described, the present invention is not limited to this type of granularity of the exposure interval subdivision, but the exposure interval subdivision may also be determined with local granularity, e.g., it may be determined individually for each pixel or, for other local pixel groups, in dependence on the image. Illustration of the advantages of the present application with regard to the embodiments comprising exposure interval subdivision per color of an image sensor may also be readily transferred to the embodiments following same.

In order to make the advantages of image-dependent exposure interval subdivision into accumulation intervals easier to understand, the problems existing in color image sensors in connection with while balancing will initially be addressed briefly.

Digital cameras are used in a wide range of applications, and in many cases, scene illumination may vary widely. However, digital image sensors are fixed with regard to their spectral sensitivities.

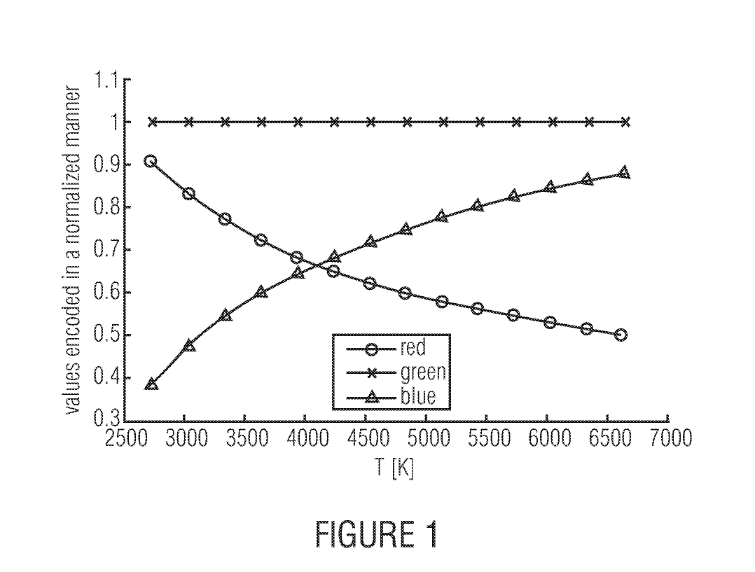

For example, if white light of a specific color temperature T impinges upon a sensor, one will see, e.g., a different output in each of the color channels. The normalized output of a typical image sensor is shown in FIG. 1. Additional processing, referred to as white balancing, may be performed in order to produce white pixels or super pixels from the pixels of the different primary colors.

### White Balancing Typically Includes Two Aspects:

Firstly, the color temperature of the illumination of the scene may be known in order to perform a correction. In the field of consumer photography, many algorithms are employed for automatically estimating the illumination color temperature. In high-end recording scenarios, such as moving pictures, the color temperature forms a controlled parameter known to the camera operator.

Secondly, the data should be adapted. Different color spaces may be used for applying multiplicative correction.

However, the problem of unbalanced color response is more serious. As will be shown in the following, the safe range for correct exposure is very much smaller than the camera dynamic range. Even though there are elaborate algorithms for improving underexposed color images with the aid of correctly exposed grey-scale images [5], said methods are complex with regard to the computational expenditure and involve many exposures. If a specific image region is overexposed, even elaborate error elimination techniques can only attempt to guess the missing information. However, this, too, is complex in terms of computation, and there is no guarantee for success.

Rather, it would be more important for the exposure to be correct initially. The embodiments described below achieve this goal. In particular, it is possible to address the limited dynamic range—as is provoked, by way of example, specifically by unbalanced colors—during detection. A few possibilities were described in the introduction to the description of the present application. However, many of said possibilities result in artifacts if there is a scene movement. The embodiments described below, however, allow digital sensitivity adaptation for pixels and/or color channels without impairing the motional blurring.

The problem of dynamic range reduction due to unbalanced color sensitivity will be explained in some more detail below.

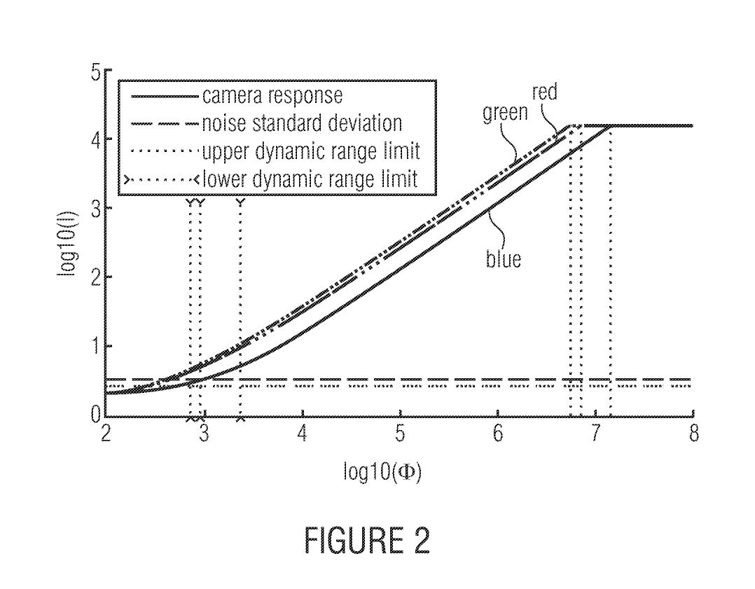

The dynamic range of image sensors is limited. In particular, the dynamic range is limited from above, specifically by clipping, and from below, specifically when the signal is swallowed up by the noise. For example, reference shall be made to FIG. 2, which indicates a typical dynamic range for a typical camera response. FIG. 2 shows pixel values in relative intensities in a log-log scale of the basis of 10. The continuous lines show the responses for each of the color channels.

As may be seen, each color channel exhibits a maximum of different intensities. The vertical doted lines on the right show the maximum intensity for each color channel. Above said intensity, no image information can be detected, and for a correctly exposed image, the scene intensities would have to remain below it.

The lower limit of the dynamic range is defined by the noise floor. The dashed horizontal line shows the standard deviation σ of the noise in the dark. The lower limit of the dynamic range is at a signal/noise ratio of 1. The dotted vertical lines on the left show the minimum intensities. Any information below said threshold will not be visible in the image but will be swallowed up by the noise.

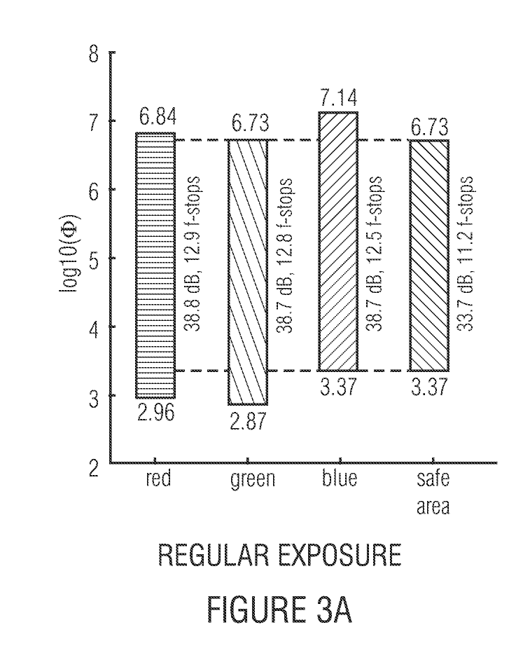

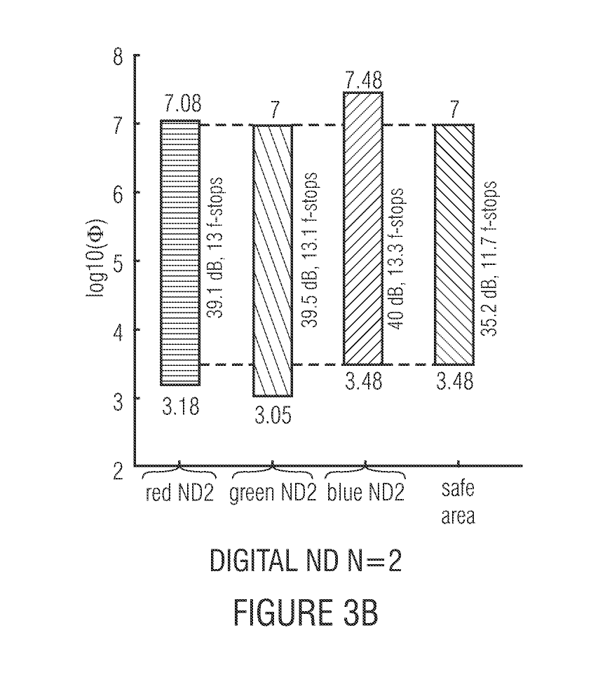

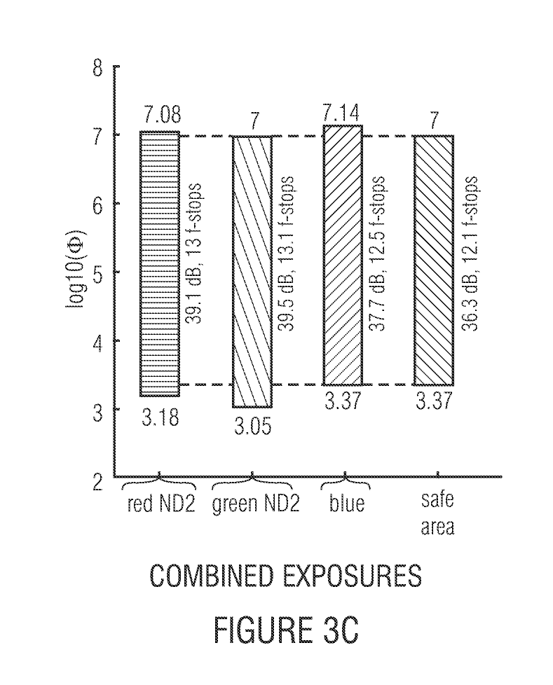

There resulting dynamic range limits are summarized in FIG. 3a. It can be seen that in relation to one another, the color channels have similar dynamic ranges of 38 dB, but different positions along the Φ axis show different relative sensitivities.

In the field of imaging one is interested in producing images with all three color channels at the same time. A safe range for exposure will then be that intensity range for which all of the color channels provide a valid image, i.e., an image wherein all of the pixels are correctly exposed, i.e., wherein the intensity is within the limits explained above. If there is a mismatch between the color channels, the exposure will have to be restricted to a dynamic range wherein all of the color channels produce valid images. This “safety range” is shown on the right-hand side of FIG. 3a. The “safe range” thus forms the intersection of all of the dynamic ranges of the individual color components, and in the example of FIG. 3a, it is reduced by about 4 dB or, put differently, by 1.5 f-stops, as compared to the individual dynamic ranges of the individual color components.

The above examples are represented for a source of white light having a correlated color temperature T=2700 K. For other light sources, a different ratio of the output signals of the color channels would result.

FIG. 1 shows the intensity ratio of the color channels across a typical range of color temperatures. The green channel has the highest sensitivity and the output signals are therefore normalized to the green output value. The red and blue channels are below same, and the reduction of the dynamic range shows across the entire range of color temperatures.

An image which is normally captured at these color temperatures, i.e., with a continuous exposure time which is the same for all colors, shows a significant color cast. A typical white balancing operation might compensate for this by multiplying the pixel values. This multiplication corresponds to a vertical shift in the color channels in FIG. 2. Said vertical shift, in turn, results in a white color response in the final images, but the dynamic range limits will remain the same.

The full dynamic range of a camera might be maintained if all of the color channels would respond to white light with the same sensitivity. An image sensor might be specifically designed to provide a balanced output for a specific color temperature. What is common is balancing for typical daylight recording conditions at T=5600 K.

In the field of analog film and photography, white balancing is sometimes achieved with optical filters. For example, a scene illuminated with tungsten filament or even the light source itself may be filtered with a color conversion filter. The camera will then see a different white balance. Said filters are still in use nowadays for high-end digital imaging. However, optical filters belong to a sensitive and expensive part of cameral equipment. Additionally, filters reduce the amount of light for all of the color channels, and the overall sensitivity is also reduced.

In order to produce balanced exposure, it would also be possible, of course, to individually set the exposure time periods of the color channels, i.e., to use different exposure intervals for the individual colors. Blurring effects, however, would then be different for the different colors, which again represents an image deterioration.

For the reasons set forth above, the following considerations result in embodiments of the present invention. In order to avoid different image properties, or different blurring in the individual pixel colors, the effective exposure time period should be the same for all colors. However, since the different color pixels, or the pixels of different colors, go into saturation at different speeds, namely in dependence on their sensitivity and the hue of the scene being captured, the exposure interval is subdivided differently for the different colors of the image sensor, e.g. into different numbers of accumulation intervals, in accordance with an embodiment of the present invention, at the ends of which readout values are read out in a respective uninterrupted readout/reset process and are finally summed to yield the pixel value. Thus, the image properties remain the same since the effective exposure time period is the same for all color pixels. However, each color may be exposed in an optimum manner, specifically to the effect that no overexposure occurs.

The decision regarding the exposure interval subdivision per color may—but need not—be made as a function of the image and/or scene, so that the dynamic range expansion may be achieved independently of the scene and/or of the image and its illumination and/or color cast. However, an improvement may also be obtained with a fixed setting of the exposure interval subdivision. For example, differences in sensitivity of the individual color pixels may be compensated for by different exposure interval subdivisions such that the dynamic range wherein all of the color pixels of a simultaneous image capturing are correctly illuminated is enlarged overall.

To illustrate this, please refer to FIGS. 3a to 3c once again. All of said figures are based on an illumination with T=2700 K. FIG. 3a was already explained above. It represents the measured dynamic ranges for regular operation of an image sensor with pixel sensors. This means that the color pixels of all of the colors were exposed continually over the exposure interval with the same exposure interval. What results is the “safe dynamic range” shown on the right-hand side. FIG. 3b shows the case where all color pixels, i.e., green, blue and red, are controlled with an equal subdivision of the exposure time interval into two equally large accumulation subintervals so as to subject the two resulting accumulation values per pixel to a summation in order to obtain the respective pixel value, whereby the dynamic range was shifted upward to due the equal subdivision of the exposure interval. As may be seen, the dynamic range thus increases by about 1.5 dB for each channel, and the dynamic range is shifted upward by about 3 dB, i.e. shifted toward brighter scenes. The resulting “safe dynamic range” has increased slightly as a result.

A more pronounced dynamic range gain, however, results in the case of FIG. 3c, wherein, specifically, the fainter pixels, namely the blue pixels, were controlled normally, i.e., with an exposure over the entire exposure time period without any intermittent uninterrupted readout/reset, whereas the more sensitive green and red pixels were controlled with equal subdivision of the exposure interval into two equally large accumulation subintervals—with subsequent summation of the readout values—so as to shift their dynamic range in accordance with FIG. 3b. Performing this shift—in a manner that is individual for each color—in the dynamic ranges for the red and green colors while maintaining the dynamic range for the blue color in accordance with FIG. 3a all in all ensures, in the case of FIG. 3c, a clearly more pronounced overlap of the individual dynamic ranges, i.e., an enlargement of the “safe dynamic range” which, again, is depicted on the right. The useable dynamic range has increased by 3 dB or, put differently, by a small f-stop as compared to the case of 3a. The effective exposure time and, thus, the motional blurring of the color channels therefore is identical for all of the three channels.

The dynamic gain that has just been described may even be increased if the exposure interval subdivision is performed as a function of the image and/or scene.

And the dynamic gain that has just been described may even be increased if in addition to the dependence on the image and/or scene even the granularity of the setting of the exposure interval subdivision is performed in dependence on the location, i.e., if the disjoint sets of pixels—these being the units in which the exposure interval subdivision may be adjusted—are separated not only in accordance with their color association but also with the lateral location within the surface of the pixel sensors of the image sensor. Specifically, if an exposure interval subdivision across the image is locally varied for pixels of the same sensitivity spectrum and/or the same color, depending on whether or not the respective part of the image sensor is brightly illuminated, the image-dependent exposure interval subdivision may even compensate for large image contrasts in that the dynamic range of respective pixels is shifted to where the amount of light is currently found at the corresponding location of the image sensor (cf. FIG. 3c).

Now that the advantages of embodiments of the present invention have been set forth and explained, embodiments of the present invention will be described in more detail below.

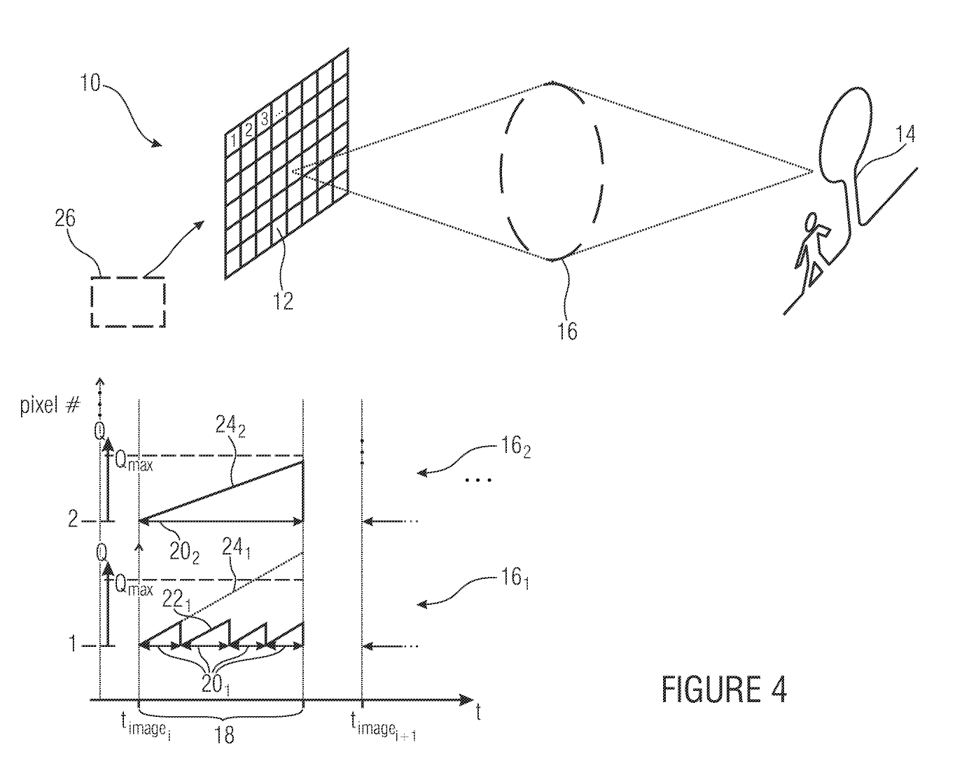

FIG. 4 shows an image sensor 10 comprising a multitude of pixel sensors 12. In the case of FIG. 4, the pixel sensors 12 are regularly arranged, by way of example, in an array in an image sensor surface—in FIG. 4 in rows and columns, by way of example, even though other arrangements, be they regular or not, are also possible. The image of an object 14 is mapped to the image sensor 10, in FIG. 4 by means of a suitable optical system 16, by way of example; however, such optical mapping is not essential, and the image sensor 10 may also be used for the purpose of capturing images that have not originated from an optical mapping.

The image sensor 10 is configured to capture an image specifically such that, during capturing of the image, each pixel sensor 12 effectively performs exposure over a shared exposure interval, but different exposure interval subdivisions into accumulation subintervals are used among the pixel sensors 12. To illustrate this in more detail, the pixel sensors 12 are indicated as being numbered, by way of example, in FIG. 4, and on the left-hand side of FIG. 4, control during image capturing is illustrated by way of example for two different pixels, here pixels number 1 and 2, by way of example. More specifically, two timing diagrams are represented one on top of the other on the left-hand side in FIG. 4, namely a timing diagram 16₁ for pixel 1 and a timing diagram 16₂ for pixel 2, and it is indicated that similar diagrams exist for the other pixel sensors 12 but are not shown in FIG. 4 for the sake of clarity. Each timing diagram exhibits a horizontal time axis and a vertical accumulation axis. The timing diagram 16₁ indicates that pixel No. 1 accumulates over the exposure interval 18. However, the exposure interval for pixel No. 1 is subdivided into four accumulation subintervals 20₁. The accumulation subintervals may be equal in size, but this is not mandatory. The accumulation subintervals do not overlap but essentially border on each other in a temporally seamless manner so as to extend essentially over the entire exposure interval 18 together. At the end of each accumulation subinterval 20₁, pixel No. 1 is read out and reset. At the end of the last accumulation subinterval 20₁ within the exposure interval 18, resetting of the pixel sensor 1 might possibly be dispensed with. In other words, at the ends of the accumulation subintervals 20₁, an accumulator of the pixel sensor is read out and then reset so as to accumulate, in a subsequent accumulation subinterval 20₁, charge carriers on account of the incident light radiation. FIG. 4 provides an exemplary indication of there being a maximum amount of charge Qₘₐₓ for the pixel sensor and/or its accumulator. Moreover, FIG. 4 indicates the time curve of the charge state at 22₁. As is indicated by the dotted line 24₁, the pixel sensor 12 of the pixel 1 would have been overexposed if the accumulation had been performed, as usual, continuously over the exposure interval 18. To obtain the pixel value of the pixel 1, the readout values obtained at the ends of the accumulation subintervals 20₁ are summed up, specifically possibly still below a weighting or without weighting, it being possible for the weighting to depend on the number of accumulation subintervals, so that the weighting factor might be 1/N, for example, wherein N=number of accumulation subintervals per exposure interval 18, or so that the weighting corresponds to the relative sensitivity of the respectively associated color of the pixel—normalized to the most sensitive color. The sum obtained is a measure of the amount of light incident on pixel 1 during the exposure time period 18.

By way of example, FIG. 4 shows that pixel 2 performs no further subdivision of the exposure interval into accumulation subintervals, or that the accumulation subinterval 20₂ corresponds to the exposure interval 18. As may be seen, pixel 2 has also not been overridden either, but its accumulation state 24₂ remains below the charge quantity threshold value Qₘₐₓ.

In other words, FIG. 4 shows that during capturing of an image it is in the non-overlapping accumulation subintervals 20₁, which essentially succeed one another without any gaps and which together form the exposure interval 18, the pixel sensor No. 1 detects a readout value in each case to obtain a number of readout values which are subjected to a summation so as to obtain a pixel value for the pixel sensor 12 at pixel No. 1, pixel No. 12 at pixel No. 2 detecting a readout value in the accumulation subinterval 20₂, said readout value representing the pixel value for this pixel sensor.

It is only by way of example that the representation of FIG. 4 is limited to the exposure interval subdivisions for two exemplary pixels. The exposure interval subdivisions of the remaining pixel sensors 12 may also vary.

The image sensor 10 may be configured such that the exposure interval subdivision into one, two or more accumulation subintervals is fixedly set for all pixel sensors 12 and is set to differ at least for two real subsets of pixel sensors. As was described above, a different exposure interval subdivision may be employed, e.g., for the more light-sensitive pixel sensors 12 of a first color sensitivity spectrum, such as the green pixels, than for pixel sensors 12 of a different color sensitivity spectrum, such as the red and/or blue pixels. In this case, for example, the exposure interval subdivision may be selected to be finer for those pixels sensors for which a reduction in sensitivity is desired, a finer exposure interval subdivision leading to a larger number of accumulation subintervals. As was explained above with reference to FIG. 3c, the dynamic range of the image sensor 10 may be increased in this manner. The pixel sensors 12 of the different color sensitivity spectra may be arranged, as is common, over the image sensor and/or laterally over the image sensor 12 in an evenly distributed manner, such as in super pixel clusters or the like. Generally, the dynamic range which may be sampled may be shifted to a desired area of higher levels of scene intensities by means of the method. For the specific case of a single pixel, the sensitivity may be shifted entirely into the range of the actual scene brightness. The grouping of pixels, for which a shared exposure interval subdivision is used, by means of the color channels is only one of several embodiments of a fixed grouping. The image sensor might also comprise groups of pixels and/or pixel sensors having different sizes and having light-sensitive areas of different sizes, and this group subdivision might be used as the basis for granularity wherein the exposure interval subdivision varies; of course, also pixel sensors having light-sensitive areas of different sizes comprise different color sensitivity spectra, “different” being understood in terms of amount and scaling, whereas different color pixels also differ with regard to the spectral shapes of their color sensitivity spectra.

Instead of a presetting, it is also possible for the image sensor 10 to comprise an exposure interval subdivider 26 configured to perform, or set, the subdivisions of the exposure interval 18 into the accumulation subintervals. The exposure interval subdivider 26 may comprise, e.g., a user interface which allows a user to control or at least influence the exposure interval subdivision. Preferably, the exposure interval subdivider is configured to be able to change the fineness of the exposure interval subdivision of different pixels relative to one another, such as the ratio of the number of accumulation subintervals per exposure interval 18, for example. It would be possible, for example, for the exposure interval subdivider 26 to comprise an operating element for a user on which the user may input a color temperature used for illuminating a scene. For very low color temperatures, for example, provision may be made for the exposure interval subdivision to be performed and/or set to be finer for the red and green pixel sensors than for the red pixel sensors, and in the case of a high color temperature, the exposure interval subdivision might be set to be finer for the colors blue and green than for the color pixel sensors of the color red.

Alternatively or additionally to providing a user influence on the exposure interval subdivision, provision may be made for the exposure interval subdivider 26 to be configured to perform the exposure interval subdivision for the pixel sensors 12 in dependence on the image or scene. For example, the exposure interval subdivider 26 might set the ratio of the exposure interval subdivision fineness among the differently colored pixel sensors automatically in dependence on a color cast, or hue, of the image to be captured or of the scene to be captured in which the image is to be captured. An embodiment will be explained later on this score. The exposure interval subdivider might obtain information about a scene color cast from dedicated color sensors or from a shot of a preceding image. FIG. 4 shows by way of example that the exposure interval 18 starts at a time t_{image(i)}, whereupon a new shot is performed at a time t_{image(i+1)}, etc. In other words, the image sensor 10 might be the part of a video camera, and for the shooting at the time t_{image(i+1)}, the exposure interval subdivision might be performed in dependence of settings that were performed for capturing the image at the time t_{image(i)}. The image shots might be performed at a frame rate 1/Δt, i.e., t_{image(i+1)}=t_{image(i)}+Δt.

Moreover, the image sensor 10 might be configured such that the exposure interval subdivider is able to differently set, during a shot, exposure interval subdivisions of pixel sensors of equal color or color sensitivity spectrum which are arranged at laterally different positions. In particular, the exposure interval subdivider might therefore be configured to perform the subdivision of the exposure interval 18 into the accumulation subintervals in dependence on the brightness of the image at the positions corresponding to the pixel sensors 12, so that the number of accumulation subintervals increases as the brightness of the image at the corresponding position increases. The exposure interval subdivider 26, in turn, might predicate the brightness at the corresponding pixel positions from previous image pick-ups or, as will be explained below, it might determine and/or estimate it by observing the current accumulation state of the respective pixel sensors 12. Local granularity in which the exposure interval subdivider 26 performs the local exposure interval subdivision might be pixel-wise, superpixel-wise or, naturally, even coarser than single pixel or single superpixel granularity.

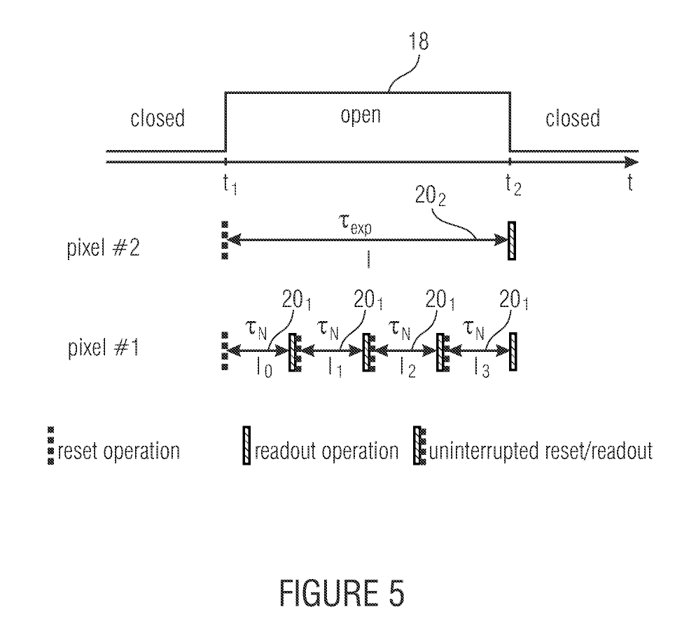

FIG. 5 once again shows, by way of example, the case of an exposure interval subdivision for pixel No. 1 into four accumulation subintervals and for pixel No. 2 into only one accumulation subinterval, specifically for the exemplary case of subdivision into equally long accumulation intervals and in a more detailed manner. The exposure interval has a length of τₑₓₚ and extends from time t₁ to time t₂. For pixel No. 2, a reset operation is performed at the beginning of the accumulation subinterval 20₂ and a readout operation is performed at the end of the accumulation subinterval 20₂. For pixel No. 1, a reset operation is performed at the beginning of the first accumulation subinterval 20₁ and a readout operation is performed at the end of the last accumulation subinterval 20₁ and an uninterrupted readout/reset operation is performed between the accumulation subintervals 20₁. Thus, FIG. 5 shows an approach wherein four essentially uninterrupted readout/reset operations are performed during the exposure interval 18 in pixel No. 1 or wherein, to be precise, three such operations are performed within the exposure interval 18 and one readout operation is performed at the at time t₂, whereby the exposure interval 18 for the pixel 1 is subdivided into four accumulation subintervals of the length τ_{N} with N=4, wherein τ_{N}=τ_{xp/N}. As may also be seen, the last operation may be limited to a readout, and the corresponding pixel sensor will be—or is still—reset at the beginning of the exposure interval 18 at the time t₁. Said resetting results in presetting of the accumulation storage which has already been mentioned above, e.g. a capacity, within the corresponding pixel sensor which will then be discharged or charged at a rate corresponding to the currently incident light stream. Said readout results in a readout value of the current charge state of the accumulation storage. The readout may be destructive, i.e., change the charge state since, after all, resetting is performed again thereafter. In FIG. 5, the exposure interval 18 has been subdivided, by way of example, into four accumulation subintervals for pixel No. 1 and into only one for pixel No. 2; however, a finer or coarser subdivision with N≧2 is also possible. Resetting of the accumulation storage may provide complete discharge. Alternatively, in accordance with a so-called skimming gate technique, resetting may be performed such that in the readout/reset operations only part of the accumulated charge is skimmed off or converted to voltage, and a different, predetermined part remains in the accumulator in which the latter part might form the target value for the reset operations, as it were.

The above mentioned readout/reset operations in FIGS. 4 and 5 involve a readout operation and a reset operation which essentially directly follow each other. Thus, essentially no light accumulation occurs between them. The ratio between the sum of the time gaps between the readout operation and the following reset operation and the time duration tₑₓₚ is, e.g., equal to or less than 9/10 or more advantageously even less than 99/100.

According to the embodiment of FIG. 5, therefore, the accumulation subintervals are equal in length. Accordingly, the image sensor of FIG. 4 therefore might be configured such that the exposure interval subdivision for the pixel sensors 12 may be performed only in such a manner that the exposure interval 18 is subdivided into equally sized accumulation subintervals in each case, i.e., that for pixel sensors 12, only N is varied; specifically, as was described above, per pixel or per color, etc.

The final pixel value i for the current frame or the current shot is then obtained in the image sensor 10 by summing the individual readout values if there are several of them, so that the following is true, for example, for the pixel values of the pixel sensors 12 of the image sensor 10:

1̅=ΣIₙ n=≡51. . . N}

wherein Iₙ be the readout value of the n^{th} accumulation interval and N be the number of accumulation intervals within an exposure interval. As can be seen, the summation may be missing if there is only one accumulation interval present, such as with pixel No. 2 in FIGS. 4 and 5, for example.

The sum might be weighted. For example, the image sensor 10 might be configured such that the pixel values of pixel sensors 12 of a first color sensitivity spectrum and/or of a first color are weighted with a first factor a_{color}_{_{—}}₁ so as to weight them differently in relation to pixel values of pixel sensors of a different color sensitivity spectrum, so that the following would be true:

1̅=a_{color}_{_{—}}₁·ΣIₙ n={1 . . . N}

The correction might ensure white balancing, i.e., it might balance out the inherent imbalance of the sensitivity of the differently colored pixel sensors when assuming a specific white light temperature. As has already been mentioned, however, there might also be other differences between the pixels, such as differences in the size of the light emitting surface area, for which a different factor a_{group}_{_{—}}₁ might then be provided, to put this in more general terms.

In the embodiment of FIG. 5, according to which the exposure interval subdivision can be performed only in equally sized accumulation subintervals, the exposure interval subdivider 26 is restricted in its work in that said exposure interval subdivider 26 also predefines, when specifying the length of the first—or any—accumulation subinterval for a pixel sensor 12 or a specific group of pixel sensors 12, such as the pixel sensors 12 of a specific color, the remaining subdivision of the exposure interval and/or the remaining subdivision of the exposure interval is inherently specified. Subsequent changes in the brightness of the image during the remaining time of the exposure interval can then no longer be taken into account by the exposure interval subdivider. In the case of FIG. 5, the exposure interval subdivider 26 may perform the division, as was described above, for example on the basis of past information such as the settings for preceding image shot or by observing the current accumulation state of a pixel 12 from the beginning of the shooting, for example to then specify N, whereupon no further “rectification” or adaptation to sudden changes in light conditions will be possible.

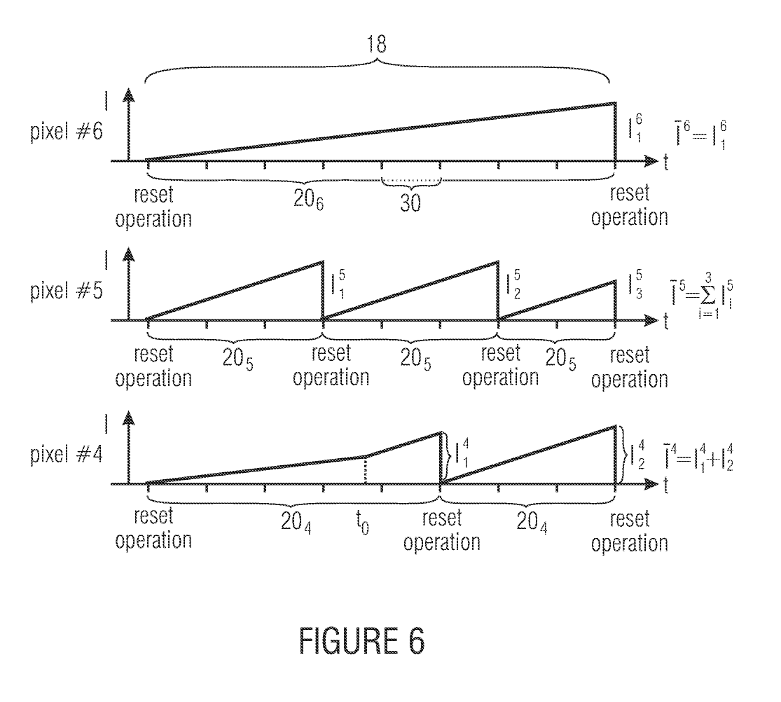

FIG. 6 shows the exposure interval subdivisions for three different pixels in accordance with a somewhat different embodiment. In accordance with the embodiment of FIG. 6, the exposure interval 18 is subdivided into a number of unit intervals which in FIG. 6 are, by way of example, eight unit intervals 30 of equal length, by way of example. In accordance with the embodiment of FIG. 6, the exposure interval subdivision here is limited to the fact that the arising accumulation subintervals 20 of an exposure interval 18 can only end or begin at the unit interval boundaries, i.e. that the uninterrupted readout/reset operations can only be at said points in time or, put in other words, the accumulation intervals in the exemplary case of FIG. 6 can be extended only in units of the unit intervals 30 so as to comprise temporal lengths corresponding to integer multiples of the length of a unit interval 30. For example, at these points in time a comparison of the current accumulation state with a specific threshold is performed, said threshold amounting to, e.g., ⅓, ⅖ or any fraction therebetween of the maximum accumulation state so as to trigger an uninterrupted readout/reset operation upon the threshold being exceeded.

It is therefore possible, in the embodiment of FIG. 6, that the exposure interval subdivider 26 is able to take into account any changes in the incident light intensity neither during the exposure interval subdivision nor during the current exposure interval 18. Such a change in the incident light intensity during the current exposure interval 18 is depicted in FIG. 6 by way of example for a pixel No. 4; in FIG. 6, a current accumulation state I is plotted for each pixel over the time t, a change in the light intensity being indicated, by way of example, at the time t₀, namely in that the accumulation state changes more quickly from this time onward. The right-hand side of FIG. 6 indicates how the respective pixel value Ī results from the individual readout values I, the superscript indices indicating the respective pixel number and the subscript indices indicating the respective readout value in the order of their being readout during the exposure interval 18.

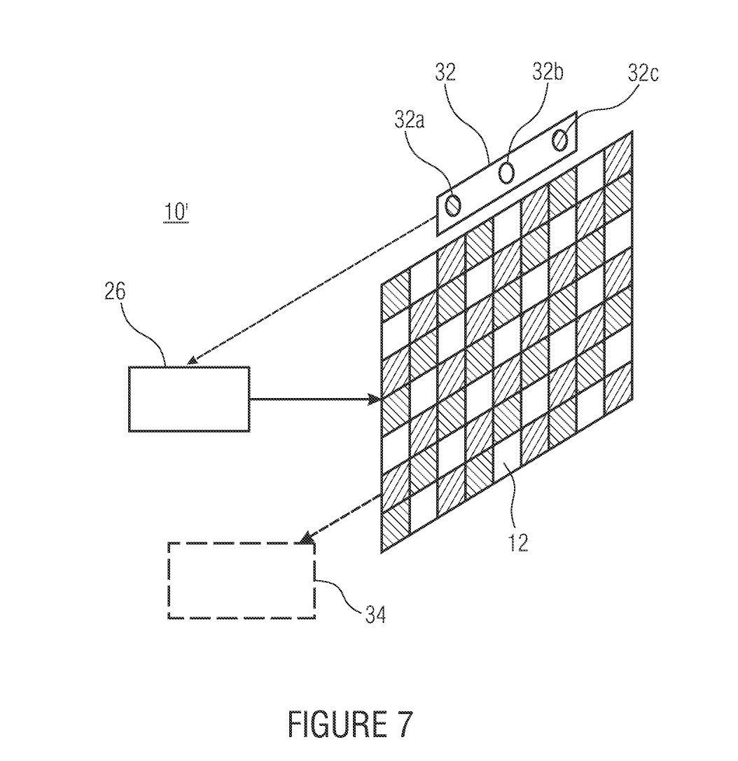

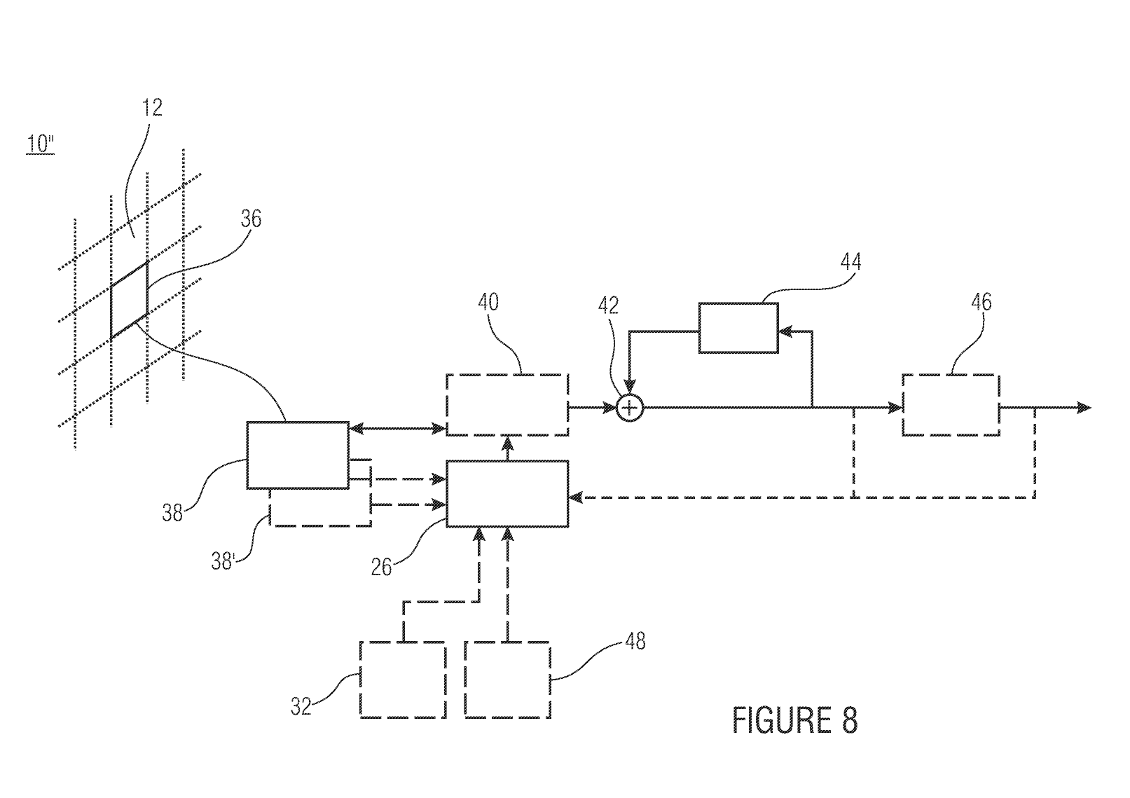

Two embodiments of an image sensor will be described below with reference to FIGS. 7 and 8; they have already been insinuated in the above description but will be described in more detail below.

FIG. 7 shows an image sensor 10′ having a multitude of pixel sensors 12 of different color sensitivity spectra, FIG. 7 depicting, by way of example, three different pixel sensor types and/or colors, namely by using different types of hatching. The three different colors are red, green and blue, for example; however, other color sensitivity spectra are also possible and the number of different colors sensitivity spectra may also be selected differently. The image sensor 10′ further comprises a sensor 32 which is specifically provided for sampling light incident on the image sensor 10′ at the different color sensitivity spectra. For example, the sensor 32 in turn comprises different sensor elements 32a, 32b and 32c whose sensitivity spectra are different from one another and whose light spectra are located at the light sensitivity spectra of the pixel sensors 12 such that they are associated with same 1:1. The image sensor 10′ of FIG. 7 further comprises an exposure interval subdivider 26 which, on the basis of the output signal of the sensor 32, determines a hue and/or a color cast of the incident light and/or which changes, in dependence thereon, the fineness of an exposure interval subdivision for the pixel sensors 12 of the different color sensitivity spectra in relation to one another, such as the number of accumulation subintervals into which the exposure interval is subdivided for capturing an image, as was described above. There may be a time offset between the measurement and/or determination of the hue and/or the color cast of the scene and the setting of the exposure interval subdivision for the individual colors of the image sensor, i.e., the color cast may be measured prior to the actual image capturing. Alternatively, the measurement for detecting the color cast of the scene may be started at the same time as the actual image capturing. In accordance with an embodiment, the exposure interval subdivider 26 may perform, e.g., the evaluation of the color cast of the scene at a predetermined point in time after the start of the exposure interval and may thereupon specify an exposure interval subdivision for one of the color sensitivity spectra such that the accumulation intervals—except for maybe one if the subdivision does not divide exactly—are located between a length of time equal to the time period between the beginning of the exposure interval and the color hue evaluation and the length of time of the entire exposure interval.

FIG. 7 further shows that the image sensor 10′ may optionally comprise a white balancer 34 configured to weight the pixels values of the pixel sensors 12 with different weightings, specifically with different weightings for the different color sensitivity spectra to which the individual pixel sensors 12 belong so as to thereby balance out the inherent sensitivity difference of the pixel sensors 12 of the different colors by means of the weightings, or so as to set a hue of the shot as desired, i.e., in accordance with a specific intension on the part of the user.

FIG. 8 shows a further embodiment of an image sensor 10″ in accordance with an embodiment of the present invention. The image sensor of FIG. 8 includes a multitude of pixel sensors 12. In place of the pixel sensors 12, FIG. 8 shows that a pixel sensor 12 comprises, e.g., a light-sensitive surface 36 and an associated accumulator 38, such as a capacitor or a different capacitance wherein charges are accumulated which are induced by light impinging on the light-sensitive surface 36 or wherein accumulated charge is discharged during resetting due to light impinging on the light-sensitive surface 36.

In accordance with FIG. 8, the accumulator 38 may be connected to a digital-to-analog converter 40 capable of converting the current charge state of the accumulator 38 to a digital value. It shall immediately be pointed out that the digital-to-analog converter 40 is not critical. Instead of a digital-to-analog converter, a different readout unit might also be provided which reads out the current accumulation state of the accumulator 38 in an analog manner and outputs it at its output.

The output of the readout unit 40 is adjoined by an adder 42, which exhibits a further output and a further input between which an intermediate storage (latch) 44 is connected. By means of this connection, the value read out by the readout unit 40 is added to a sum of the values of the same pixels which were previously readout in the same exposure interval. At the end of an exposure interval, thus, the summed value of the readout values of the respective pixel sensor 12 is present at the output of the adder 42, it being possible for a weighting unit 46 to optionally adjoin the output of the adder 42, which weighting unit may perform, e.g., the above-mentioned color-dependent weighting of the pixel value, so that the pixel value of the pixel considered would be present in a weighted manner at the output of the optional weighting unit 46.

The image sensor 10″ further includes an exposure interval subdivider 26 which sets, for the pixel sensor considered in FIG. 8 by way of example, the exposure interval subdivision and correspondingly controls the readout unit 40 to read out and reset the accumulation state of the accumulator 38 at the end or ends of the accumulation subintervals.

Now that the architecture of the image sensor of FIG. 8 has been described above, its mode of operation will be described below. Prior to exposure of an image, the intermediate storage 44 is reset to 0. The accumulator 38 is also reset, and care is taken to ensure that the accumulation across the light-sensitive surface 36 is not effected until the start of the exposure interval, i.e., at the first accumulation subinterval. By this time, the exposure interval subdivider 26 has either already determined or is yet to determine the setting of the exposure interval subdivision. As was mentioned above, the exposure interval subdivider 26 may be influenced in its determination by a user input means 48 or a dedicated sensor 32. Alternatively or additionally, the exposure interval subdivider 26 may also observe the current accumulation state of the accumulator 38, for example by means of a comparator, which compares the accumulation state, as was mentioned above, with a predetermined value and causes one of the uninterrupted readout/reset operations if the latter value is exceeded. It is also possible for the exposure interval subdivider 26 to observe the accumulator 38′ of a representative pixel sensor of the image sensor 10″ so as to deduce the accumulation state of the accumulator 38 of the current pixel sensor 12 and/or to use the accumulation state of this representative accumulator 38′ as an estimation value for the accumulation state of the accumulator 38 so as to then, as was described above, set the exposure interval subdivision during the current exposure interval. This representative pixel sensor might be located, e.g., in the line which is preceding in a line readout scanning direction. As is further indicated by dashed lines, the exposure interval subdivider 26 may also use the pixel value of the pixel sensor 12 for a preceding image shot as a prediction of the level of brightness with which the pixel is (will be) illuminated in the current image shot so as to accordingly perform the exposure interval subdivision for the current exposure interval.

In the event that the exposure interval subdivision is individually set for each pixel, the exposure interval subdivider 26 may comprise one comparator per pixel sensor 12, for example.

It shall be pointed out that the read-out values at the output of the readout unit 40 advantageously have a linear relationship with the amount of light impinging on the light-sensitive surface of the corresponding pixel sensor in the corresponding accumulation interval. It is possible that for linearization, a correction of the otherwise non-linear readout values is performed, such as by a linearizer (not shown) which is placed between the output of the readout unit 40 and the adder 42 and which applies, e.g., a corresponding linearization curve to the values and maps the latter to the linearized values in accordance with said curve. Alternatively, linearization may take place inherently in the readout process, such as in a digitization. An analog circuit might also be used. Additionally, a compensation of the dark current might be provided in the event of exposure times of different lengths, specifically even prior to the actual accumulation. Resetting of the accumulator may also be performed differently than by means of complete discharge, as was mentioned above. Rather, said resetting may be performed, in accordance with the skimming gate technique, such that during readout, only part of the accumulated charge is ever skimmed off and/or converted to voltage and another part remains within the accumulator.

Thus, the above embodiments show a possibility of performing an adaptation of the dynamic range of an image sensor for individual pixels or pixel groups. In accordance with specific embodiments it is possible, for example, for the exposure interval subdivision into accumulation subintervals to be adjusted more finely for red image points if the scene is illuminated with an incandescent lamp. Specifically, there will be clearly more red within the scene as a result, and the red channel will probably be the first to go into saturation. However, a finer subdivision of the exposure interval leads, as was described with reference to FIGS. 3a to 3c, to a shift of the dynamic range toward more brightness, so that this approach for red image points would overall result in a larger signal range. On the other hand, it is also possible to perform the exposure interval subdivision such that image points in bright image areas undergo a finer exposure interval subdivision, so that all in all, shooting of scenes with a very high dynamic is enabled. FIG. 6 shows different cases, which are representative for various pixels 4, 5 and 6; the intensity I, which has been integrated so far, has been plotted over time. Dark image areas are then detected within only one single exposure, for example, as is shown with pixel 6. The approach enables a high sensitivity of the image sensor. Bright image areas are read out and exposed several times, such as in the case of pixels 4 and 5. This results in a reduction of the sensitivity and/or in a shift of the dynamic range toward more brightness. In the event of movement in the image of the image shot, classification of the portions may be adapted.

The above embodiments may use a sensor which may reset individual image points and thus start exposure, whereas other image points or pixel sensors continue exposure. A controller, which may be arranged within the image sensor or sensor chip or may be arranged externally, may decide, depending on the brightness from past images or from the current brightness, which image points are reset. Thus, the system might control itself. As was described above, the exposure interval subdivision might then be performed at each point in time of readout in such a manner that each individual image point will not overflown in the next time segment.

Returning once again to the example of FIG. 6, an image point having little intensity on its light-sensitive surface may perform only one single exposure during the exposure interval, for example, whereas a bright image point is reset once or several times during the exposure interval, the intensity then being composed of the individual readout values at the time(s) of the reset(s). An image point, e.g., pixel 4 in FIG. 6, which is illuminated darkly initially and thus starts with a long accumulation subinterval, may subsequently undergo a finer subdivision of the exposure interval even while in the same exposure interval. For example, a bright object moves in the direction of the image point, from which time on shorter accumulation intervals may be used.

Since in accordance with the above embodiments the exposure at each image point, or pixel, along the entire exposure time and/or exposure interval takes into account any information about changes in the intensity, the images produced have no artifacts caused by the exposure interval subdivision and/or the sampling, and both bright and dark image areas have the same amount of motional blurring. Thus, the shots that are taken of HDR sequences in the case of a sequence of image shots are also suitable for the high-quality image shots.

In addition, by means of the above embodiments, complete spatial resolution of the respective image sensor may be exploited. No pixels are provided for other levels of brightness which might not be used in the current scene brightness. The minimum sensitivity of an image sensor need not be changed since no expensive circuits need to be accommodated in each of the pixels.

With regard to above embodiments it shall be further pointed out that it is readily possible to design the above image sensors with a single CMOS sensor and, optionally, with suitable optics. Additional mechanics/optics may not necessarily be used.

In particular, in the case of FIG. 8 it is possible, for example, for the multitude of pixel sensors to be integrated in a semiconductor chip or chip module together. The accumulator is also integrated in same, specifically in a 1:1 association, i.e., precisely one accumulator for each sensor 12. Alternatively, it would also be possible for there to be several accumulators per sensor which are then used in the successive accumulation intervals of an exposure interval. The readout unit 40 may also be integrated in the semiconductor chip or chip module, specifically once for each pixel or once for each group, such as a line, of pixels. The exposure interval subdivider 26 might also be integrated in the semiconductor chip or chip module—with one comparator per pixel or pixel group—and the components 42 and 44 and/or 46 might be integrated in the chip, specifically per readout unit, pixel, etc. Even the additional sensor might be implemented thereon, or at least terminals for 32 and/or 48 are provided if the latter are present.

With regard to the above embodiments it shall further be pointed out that the decision about resetting the image point may be made either directly in the readout circuits of the sensor or following digitization of the image. The decision may be made on the basis of the intensity of the previous image, as was described above or, as was also described above, an adaptation to the current intensity of each individual image point may be made. If a bright object moves in front of the image point during shooting, a short readout will not make sense before this point in time.

Above embodiments therefore offer the possibility of providing a camera which might have a very high bit repetition rate, specifically a camera with an extended dynamic range. In particular, there is the possibility, with above embodiments, to obtain cameras for shooting films with a large dynamic range, high resolution and very high image quality. Particularly with large-area projection such as in the cinema, for example, recording of the correct motional blurring is an important element, and above embodiments allow achieving this goal.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or actually do cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.
[1] E. P. Rennett and L. McMillan. Video enhancement using per-pixel virtual exposures. In ACM SIGGRAPH 2005 Papers, p. 852. ACM, 2005.
[2] P E Debevec and J. Malik. Recovering high dynamic range radiance maps from photographs. The ACM SIGGRAPH 97, 1997.
[3] B. Fowler and P.D.I.I. PDI. Low Noise Wide Dynamic Range Image Sensor Readout using Multiple Reads During Integration (MRDI). Technical report, Technical Report, 2002.
[4] A. Kachatkou and R. van Silfhout. Dynamic range enhancement algorithms for CMOS Sensors with non-destructive readout. In IEEE International Workshop on Imaging Systems and Techniques, 2008. IST 2008, pages 132-137, 2008.
[5] S. B. Kang, M. Uyttendaele, S. Winder, and R. Szeliski. High dynamic range video. ACM Transactions on Graphics, 22(3):319-325, 2003.
[6] S. Kavusi, K. Ghosh, and A. El Gamal. Architectures for high dynamic range, high speed image sensor readout circuits. International Federation for Information Processing Publications IFIP, 249:1, 2008.
[7] Sam Kavusi and Abbas El Gamal. Quantitative study of high-dynamicrange image sensor architectures. In SPIE Sensors and Camera Systems for Scientific, Industrial, and Digital Photography Applications V, volume 5301, pages 264-275. SPIE, 2004.
[8] T. Kijima, H. Nakamura, J. T. Compton, and J. F. Hamilton. Image sensor with improved light sensitivity, Jan. 27, 2006. U.S. patent application Ser. No. 11/341,210.
[9] . Liu and A. El Gamal. Photocurrent estimation from multiple nondestructive samples in CMOS image sensor. In Proceedings of SPIE, Vol. 4306, p. 450, 2001.
[10]X. Liu and A. El Gamal. Synthesis of high dynamic range motion blur free image from multiple captures. IEEE Transaction.s on Circuits and Systems 1: Fundamental Theory and Applications, 50(4):530-539, 2003.
[11] M. Schoberl and A. Oberdorster and and S. Föβel and H. Bloss and A. Kaup. Digital neutral density filter for moving picture cameras. In SPIE Electronic Imaging, Computational Imaging VIIL SPIE, 1 2010.
[12]Shree K. Nayar and Tomoo Mitsunaga. High dynamic range imaging: spatially varying pixel exposures. Computer Vision and Pattern Recognition, IEEE Computer Society Conference on, 1:1472, 2000.
[13] S. K. Nayar and V. Branzoi. Adaptive dynamic range imaging: Optical control of pixel exposures over space and time. In Proceedings of the Ninth IEEE International Conference an Computer Vision, page 1168, 2003.
[14]S. O. Otim, D. Joseph, B. Choubey, and S. Collins. Modelling of high dynamic range logarithmic CMOS image sensors. Proceedings of the 21st IEEE Instrument ation and Measurement Technology Conference IMTC, 1:451-456, May 2004.
[15] R. A. Street. High dynamic range segmented pixel sensor array, Aug. 4 1998. U.S. Pat. No. 5,789,737.
[16] J. Unger and S. Gustayson. High-dynamic-range video for photometric measurement of illumination. In Proceedings of SPIE, volume 6501, page 65010E, 2007.
[17] Hongcheng Wang, Ramesh Rastcar, and Nareudra Ahuja. High dynamic ringe video Ersing split aperture camera. In IEEE 6th Workshop an Omnidirectional Vision, Camera Networks and Non-classical Cameras OMNIVIS, 2005.

1. An image sensor comprising a multitude of pixel sensors, the image sensor being configured to capture an image and is configured such that during capture of the image a first pixel sensor in each one of a first number of non-overlapping first accumulation intervals which succeed each other in an essentially uninterrupted manner and together yield an exposure interval detects one value in each case so as to achieve a number of values which, if the first number is larger than 1, are subjected to a summation so as to achieve a pixel value for the first pixel sensor, and a second pixel sensor in each of a second number of non-overlapping second accumulation intervals which succeed each other in an essentially uninterrupted manner and together yield the exposure interval, detects a value so as to achieve a number of values which, if the second number is larger than 1, are subjected to a summation so as to achieve a pixel value for the second pixel sensor, a subdivision of the exposure interval into the first accumulation intervals differing from a subdivision of the exposure interval into the second accumulation intervals, wherein the multitude of pixel sensors comprise pixel sensors of a first color sensitivity spectrum and pixel sensors of a second color sensitivity spectrum, the first pixel sensor belonging to the pixel sensors of the first color sensitivity spectrum, and the second pixel sensor belonging to the pixel sensors of the second color sensitivity spectrum, the image sensor being configured such that the subdivision of the exposure interval into accumulation intervals for the pixel sensors of the first color sensitivity spectrum and the pixel sensors of the second color sensitivity spectrum is identical, but for the pixel sensors of the first color sensitivity spectrum is different from that for the pixel sensors of the second color sensitivity spectrum.

2. The image sensor as claimed in claim 1, comprising an exposure interval subdivider configured to set the subdivisions of the exposure interval into the first and/or second accumulation intervals in dependence on light originating from a scene in which the image is captured.

3. The image sensor as claimed in claim 2, wherein the exposure interval subdivider comprises a sensor, in addition to the multitude of pixel sensors, which is configured to detect a hue of light impinging on the image sensor.

4. The image sensor as claimed in claim 1, wherein the image sensor comprises an exposure interval subdivider configured to perform the subdivisions of the exposure interval into the first and second accumulation intervals in dependence on how much of a medium color spectrum of the image is in the first and/or second color spectra, such that the number of the first accumulation intervals is larger than the number of the second accumulation intervals when the pixel sensors of the first color sensitivity spectrum are more sensitive to the medium color spectrum of the image than the pixel sensors of the second color sensitivity spectrum, and vice versa.

5. The image sensor as claimed in claim 4, wherein the exposure interval subdivider is configured to observe a currently accumulated amount of light of at least one of the pixel sensors of the first color sensitivity spectrum and at least one of the pixel sensors of the second color sensitivity spectrum and to end a current accumulation interval for the pixel sensors of the first and/or second color sensitivity spectrum and to start a new one when the currently accumulated amount of light of the at least one pixel sensor of the respective color sensitivity spectrum exceeds a predetermined amount.

6. The image sensor as claimed in claim 1, further comprising a white balancer configured to cause pixel values of pixel sensors of a first color sensitivity spectrum to be weighted differently in relation to pixel values of a second color sensitivity spectrum.

7. A camera comprising an image sensor, said image sensor comprising:
a multitude of pixel sensors, the image sensor being configured to capture an image and is configured such that during capture of the image a first pixel sensor in each one of a first number of non-overlapping first accumulation intervals which succeed each other in an essentially uninterrupted manner and together yield an exposure interval detects one value in each case so as to achieve a number of values which, if the first number is larger than 1, are subjected to a summation so as to achieve a pixel value for the first pixel sensor, and a second pixel sensor in each of a second number of non-overlapping second accumulation intervals which succeed each other in an essentially uninterrupted manner and together yield the exposure interval, detects a value so as to achieve a number of values which, if the second number is larger than 1, are subjected to a summation so as to achieve a pixel value for the second pixel sensor, a subdivision of the exposure interval into the first accumulation intervals differing from a subdivision of the exposure interval into the second accumulation intervals, wherein the multitude of pixel sensors comprise pixel sensors of a first color sensitivity spectrum and pixel sensors of a second color sensitivity spectrum, the first pixel sensor belonging to the pixel sensors of the first color sensitivity spectrum, and the second pixel sensor belonging to the pixel sensors of the second color sensitivity spectrum, the image sensor being configured such that the subdivision of the exposure interval into accumulation intervals for the pixel sensors of the first color sensitivity spectrum and the pixel sensors of the second color sensitivity spectrum is identical, but for the pixel sensors of the first color sensitivity spectrum is different from that for the pixel sensors of the second color sensitivity spectrum.

8. A method of capturing an image with a multitude of pixel sensors, the method comprising the following in capturing the image:
controlling a first pixel sensor, so that in each one of a first number of non-overlapping first accumulation intervals which succeed each other in an essentially uninterrupted manner and together yield an exposure interval, said first pixel sensor detects one value in each case so as to achieve a number of values while—if the first number is larger than 1—summing the values so as to achieve a pixel value for the first pixel sensor, and
controlling a second pixel sensor, so that in each of a second number of non-overlapping second accumulation intervals which succeed each other in an essentially uninterrupted manner and together yield the exposure interval, said second pixel sensor detects a value so as to achieve a number of values while—if the second number is larger than 1—summing the values so as to achieve a pixel value for the second pixel sensor,
a subdivision of the exposure interval into the first accumulation intervals differing from a subdivision of the exposure interval into the second accumulation intervals,
the multitude of pixel sensors comprising pixel sensors of a first color sensitivity spectrum and pixel sensors of a second color sensitivity spectrum,
the first pixel sensor belonging to the pixel sensors of the first color sensitivity spectrum, and the second pixel sensor belonging to the pixel sensors of the second color sensitivity spectrum,
the subdivision of the exposure interval into accumulation intervals for the pixel sensors of the first color sensitivity spectrum and the pixel sensors of the second color sensitivity spectrum being identical to one another, but being different for the pixel sensors of the first color sensitivity spectrum from that for the pixel sensors of the second color sensitivity spectrum.

9. A non-transitory computer readable medium including a computer program comprising a program code for performing the method, when the program runs on a computer, of capturing an image with a multitude of pixel sensors, the method comprising the following in capturing the image:
controlling a first pixel sensor, so that in each one of a first number of non-overlapping first accumulation intervals which succeed each other in an essentially uninterrupted manner and together yield an exposure interval, said first pixel sensor detects one value in each case so as to achieve a number of values while—if the first number is larger than 1—summing the values so as to achieve a pixel value for the first pixel sensor, and
controlling a second pixel sensor, so that in each of a second number of non-overlapping second accumulation intervals which succeed each other in an essentially uninterrupted manner and together yield the exposure interval, said second pixel sensor detects a value so as to achieve a number of values while—if the second number is larger than 1—summing the values so as to achieve a pixel value for the second pixel sensor,
a subdivision of the exposure interval into the first accumulation intervals differing from a subdivision of the exposure interval into the second accumulation intervals,
the multitude of pixel sensors comprising pixel sensors of a first color sensitivity spectrum and pixel sensors of a second color sensitivity spectrum,
the first pixel sensor belonging to the pixel sensors of the first color sensitivity spectrum, and the second pixel sensor belonging to the pixel sensors of the second color sensitivity spectrum,
the subdivision of the exposure interval into accumulation intervals for the pixel sensors of the first color sensitivity spectrum and the pixel sensors of the second color sensitivity spectrum being identical to one another, but being different for the pixel sensors of the first color sensitivity spectrum from that for the pixel sensors of the second color sensitivity spectrum.
